(19) United States
(12) Patent Application Publication
(10) Pub. No.: US 2013/0136341 A1
(43) Pub. Date: May 30, 2013

(54) ELECTRONIC APPARATUS AND THREE-DIMENSIONAL MODEL GENERATION SUPPORT METHOD

(71) Applicant: KABUSHIKI KAISHA TOSHIBA, Tokyo (JP)

(72) Inventor: Koji Yamamoto, Ome-shi (JP)

(73) Assignee: KABUSHIKI KAISHA TOSHIBA, Tokyo (JP)

(21) Appl. No.: 13/689,289

(22) Filed: Nov. 29, 2012

(30) Foreign Application Priority Data
Nov. 29, 2011 (JP) 2011-260795

(51) Int. Cl. G06T 17/00

(52) U.S. Cl. CPC G06T 17/00
USPC 382/154

(57) ABSTRACT

According to one embodiment, an electronic apparatus includes a 3D model generator, a capture position estimation module and a notification controller. The 3D model generator generates 3D model data of a 3D model by using images in which a target object of the 3D model is captured. The capture position estimation module estimates a capture position of a last captured image of the images. The notification controller notifies a user of a position at which the object is to be next captured, based on the generated 3D model data and the estimated capture position. The 3D model generator updates the 3D model data by further using a newly captured image of the object.

### CROSS-REFERENCE TO RELATED APPLICATIONS

This application is based upon and claims the benefit of priority from prior Japanese Patent Application No. 2011-260795, filed Nov. 29, 2011, the entire contents of which are incorporated herein by reference.

### FIELD

Embodiments described herein relate generally to an electronic apparatus which generates a three-dimensional model data, and a three-dimensional model generation support method which is applied to the electronic apparatus.

### BACKGROUND

There have been proposed various three-dimensional (3D) reconstruction methods of creating a 3D model data of an object by using images obtained by capturing the object. One of such methods is a shape from silhouette method (view volume intersection method). The shape from silhouette method is a method of estimating a 3D shape of an object by using a silhouette image. In the shape from silhouette method, a 3D shape of an object is estimated, based on such a silhouette constraint that the object is included in a view volume in which a silhouette of the object is projected in a real space. In the shape from silhouette method, intersections (visual hulls) of view volumes corresponding to a plurality of silhouette images is calculated as a 3D shape of the object. Thus, by capturing (capturing) the object from various positions and postures of a camera, the calculated 3D shape can be made to closer to the object.

In the above-described method, in order to obtain a proper 3D model, it is necessary to capture the object from various positions and postures of the camera. However, it is difficult for the user, who is capturing the object, to determine whether enough images to obtain a proper 3D model have been captured. This being the case, there has been proposed a method of generating a 3D model while capturing the object, and notifying the user of the end of capture when a proper 3D model has been generated. Thereby, it becomes possible to prevent the failure to obtain enough images to create a proper 3D model, or to prevent the user from continuing the capture, despite enough images to create a proper 3D model having been obtained.

However, in the method of notifying the user of the end of capture, it is difficult to efficiently capture the object. For example, it is difficult for the user to exactly recognize an already captured area and a yet-to-be captured area of the surface of the object. In addition, depending on the position or posture of capture, it is possible that occlusion occurs at a part of the object. There is a possibility that it is difficult for the user to perform capture by taking into account the effect due to occlusion.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an example of the external appearance of an electronic apparatus according to an embodiment.

FIG. 2 is a block diagram illustrating an example of the structure of the electronic apparatus of the embodiment.

FIG. 3 is an exemplary view for explaining an example of the operation for 3D model generation using the electronic apparatus of the embodiment.

FIG. 4 is an exemplary block diagram illustrating an example of the configuration of a 3D model generation program which is executed by the electronic apparatus of the embodiment.

FIG. 5 is an exemplary conceptual view for explaining an example of a missing-area direction which is instructed by the electronic apparatus of the embodiment.

FIG. 6 is an exemplary view illustrating an example of the structure of a vibrator for instructing a capturing location by the electronic apparatus of the embodiment.

FIG. 7 is an exemplary view illustrating an example of the arrangement of vibrators which are provided in the electronic apparatus of the embodiment.

FIG. 8 is an exemplary flowchart illustrating an example of the procedure of a 3D model generation process which is executed by the electronic apparatus of the embodiment.

FIG. 9 is an exemplary flowchart illustrating another example of the procedure of the 3D model generation process which is executed by the electronic apparatus of the embodiment.

FIG. 10 is an exemplary flowchart illustrating an example of the procedure of a missing-area direction determination process which is executed by the electronic apparatus of the embodiment.

### DETAILED DESCRIPTION

Various embodiments will be described hereinafter with reference to the accompanying drawings.

In general, according to one embodiment, an electronic apparatus includes a three-dimensional model generator, a capture position estimation module and a notification controller. The three-dimensional model generator generates three-dimensional model data of a three-dimensional model by using a plurality of images in which a target object of the three-dimensional model is captured. The capture position estimation module estimates a capture position of a last captured image of the plurality of images. The notification controller notifies a user of a position at which the object is to be next captured, based on the generated three-dimensional model data and the estimated capture position. The three-dimensional model generator updates the three-dimensional model data by further using a newly captured image of the object.

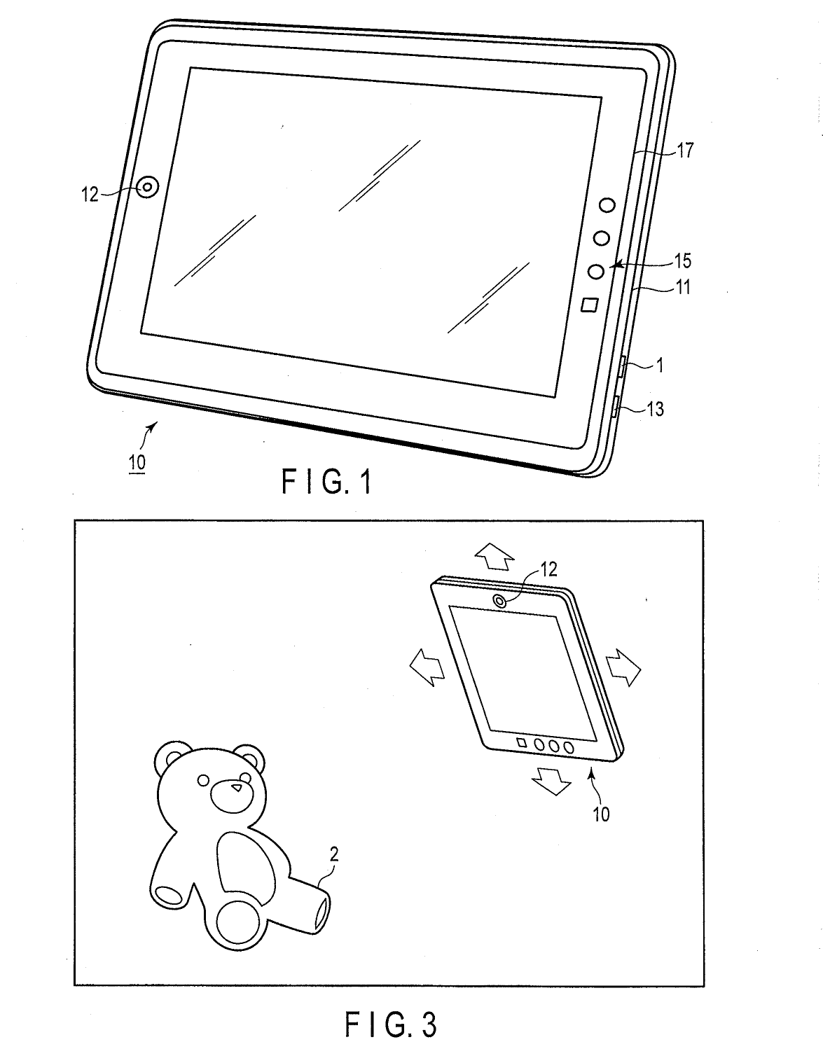

FIG. 1 is a perspective view illustrating the external appearance of an electronic apparatus according to an embodiment. This electronic apparatus is realized, for example, as a tablet-type personal computer (PC) 10. In addition, the electronic apparatus may be realized as a smartphone, a PDA, a notebook-type PC, etc. As shown in FIG. 1, the computer 10 includes a computer main body 11 and a touch-screen display 17.

The computer main body 11 has a thin box-shaped housing. A liquid crystal display (LCD) 17A and a touch panel 17B are built in the touch-screen display 17. The touch panel 17B is provided so as to cover the screen of the LCD 17A. The touch-screen display 17 is attached to the computer main body 11 in such a manner that the touch-screen display 17 is laid over the top surface of the computer main body 11. In addition, a camera module 12 and operation buttons 15 are disposed at end portions surrounding the screen of the LCD 17A. The camera module 12 may be disposed on the back surface of the computer main body 11.

A power button for powering on/off the computer 10, a volume control button, a memory card slot, etc. are disposed on an upper side surface of the computer main body 11. A speaker, etc. are disposed on a lower side surface of the computer main body 11. A right side surface of the computer main body 11 is provided with a universal serial bus (USB) connector 13 for connection to a USB cable or a USB device of, e.g. the USB 2.0 standard, and an external display connection terminal 1 supporting the high-definition multimedia interface (HDMI) standard. This external display connection terminal 1 is used in order to output a digital video signal to an external display. The camera module 12 may be an external camera which is connected via the USB connector 13 or the like.

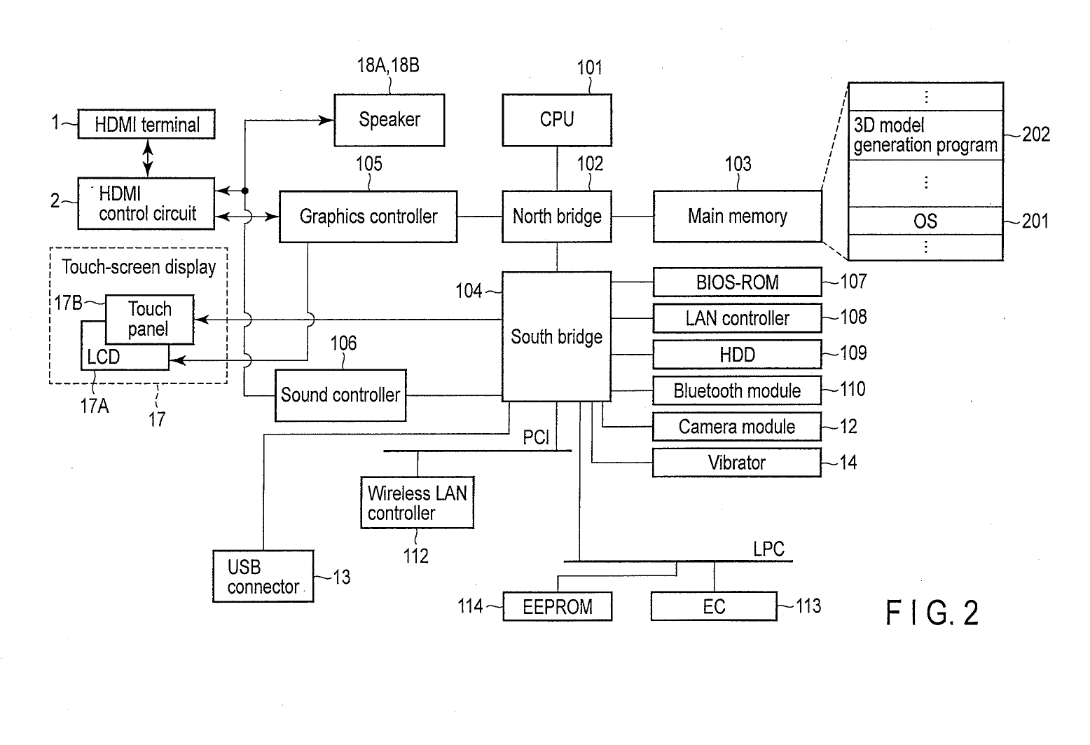

FIG. 2 shows the system configuration of the computer 10.

The computer 10, as shown in FIG. 2, includes a CPU 101, a north bridge 102, a main memory 103, a south bridge 104, a graphics controller 105, a sound controller 106, a BIOS-ROM 107, a LAN controller 108, a hard disk drive (HDD) 109, a Bluetooth® module 110, a camera module 12, a vibrator 14, a wireless LAN controller 112, an embedded controller (EC) 113, an EEPROM 114, and an HDMI control circuit 2.

The CPU 101 is a processor for controlling the operation of the respective components of the computer 10. The CPU 101 executes an operating system (OS) 201, a three-dimensional model generation program (3D model generation program) 202 and various application programs, which are loaded from the HDD 109 into the main memory 103. The 3D model generation program 202 includes a 3D model generation function for generating 3D model data by using images captured by the camera module 12. For example, using the camera module 12, the user (photographer) captures a target object, 3D model data of which is to be generated, from the surrounding of the target object. Thereby, the camera module 12 generates images in which the target object has been captured from various positions and postures. The camera module 12 outputs the generated images to the 3D model generation program 202. Using the images generated by the camera module 12, the 3D model generation program 202 generates 3D model data of the target object. In the meantime, the 3D model generation program 202 may generate 3D model data of the target object by using image frames included in a moving picture (video) which is generated by the camera module 12.

Besides, the CPU 101 executes a BIOS that is stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of communicating with the graphics controller 105 via, e.g. a PCI EXPRESS serial bus.

The graphics controller 105 is a display controller which controls the LCD 17A that is used as a display monitor of the computer 10. A display signal, which is generated by the graphics controller 105, is sent to the LCD 17A. The LCD 17A displays video, based on the display signal.

The HDMI terminal 1 is the above-described external display connection terminal. The HDMI terminal 1 is capable of sending a non-compressed digital video signal and digital audio signal to an external display device, such as a television (TV), via a single cable. The HDMI control circuit 2 is an interface for sending a digital video signal to the external display device, which is called “HDMI monitor”, via the HDMI terminal 1.

The south bridge 104 controls devices on a Peripheral Component Interconnect (PCI) bus and devices on a Low Pin Count (LPC) bus. The south bridge 104 includes an Integrated Drive Electronics (IDE) controller for controlling the HDD 109.

The south bridge 104 includes a USB controller for controlling the touch panel 17B. The touch panel 17B is a pointing device for executing an input on the screen of the LCD 17A. The user can operate a graphical user interface (GUI), or the like, which is displayed on the screen of the LCD 17A, by using the touch panel 17B. For example, by touching a button displayed on the screen, the user can instruct execution of a function associated with the button. In addition, the USB controller communicates with an external device, for example, via a cable of the USB 2.0 standard which is connected to the USB connector 13.

The south bridge 104 also has a function of communicating with the sound controller 106. The sound controller 106 is a sound source device and outputs audio data, which is a target of playback, to the speakers 18A and 18B. The LAN controller 108 is a wired communication device which executes wired communication of, e.g. the IEEE 802.3 standard. The wireless LAN controller 112 is a wireless communication device which executes wireless communication of, e.g. the IEEE 802.11g standard. The Bluetooth module 110 executes Bluetooth communication with an external device.

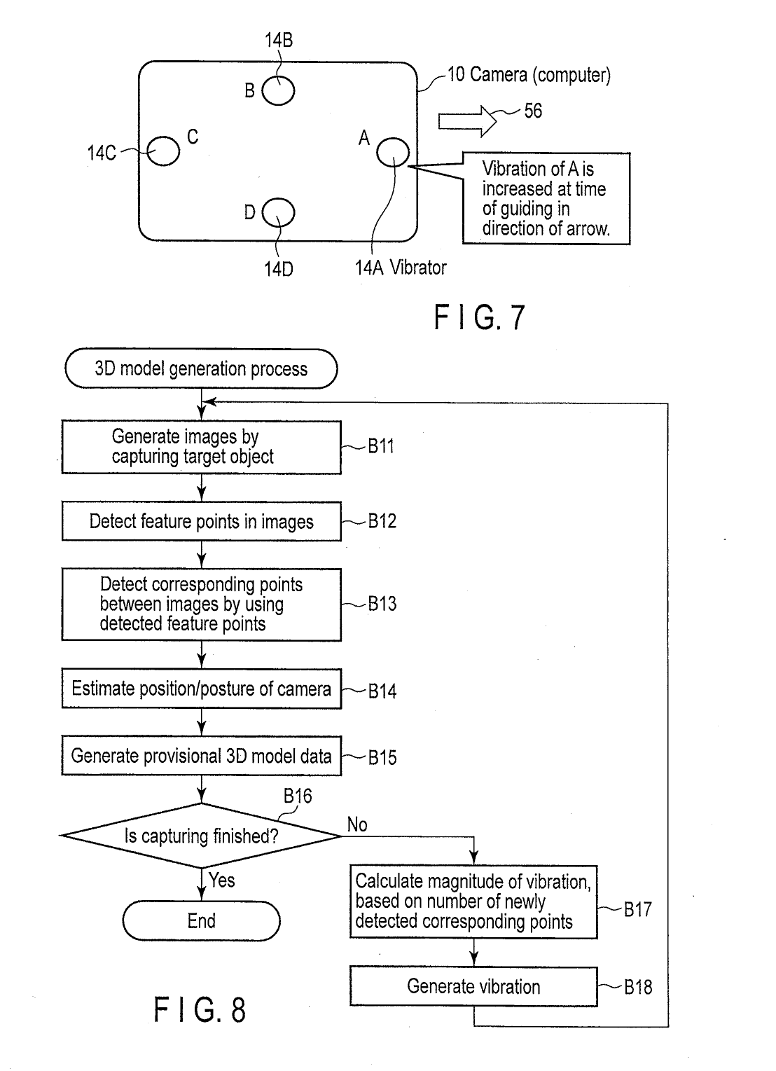

The vibrator 14 is configured to generate vibration. The vibrator 14 can generate vibration of a designated magnitude. In addition, the vibrator 14 can generate vibration in a designated direction. The structure of the vibrator 14 will be described later with reference to FIGS. 6 and 7.

The EC 113 is a one-chip microcomputer including an embedded controller for power management. The EC 113 has a function of powering on/off the computer 10 in accordance with the user's operation of the power button.

Next, FIG. 3 illustrates the state in which a target object 2, 3D model data of which is to be created, is captured from the surrounding thereof. The user moves the camera module 12 (electronic apparatus 10) around the object 2, thereby capturing the object 2 from various positions and postures. The 3D model generation program 202 generates 3D model data corresponding to the object 2, by using images obtained by the capturing. With the surface of the object 2 being completely captured, the 3D model generation program 202 can create a good 3D model with no missing area. In the electronic apparatus 10, the user is notified of a position (posture) at which the object 2 is to be next captured, by vibration by the vibrator 14, sound produced by the speaker 18A, 18B, and information displayed on the screen of the LCD 17A.

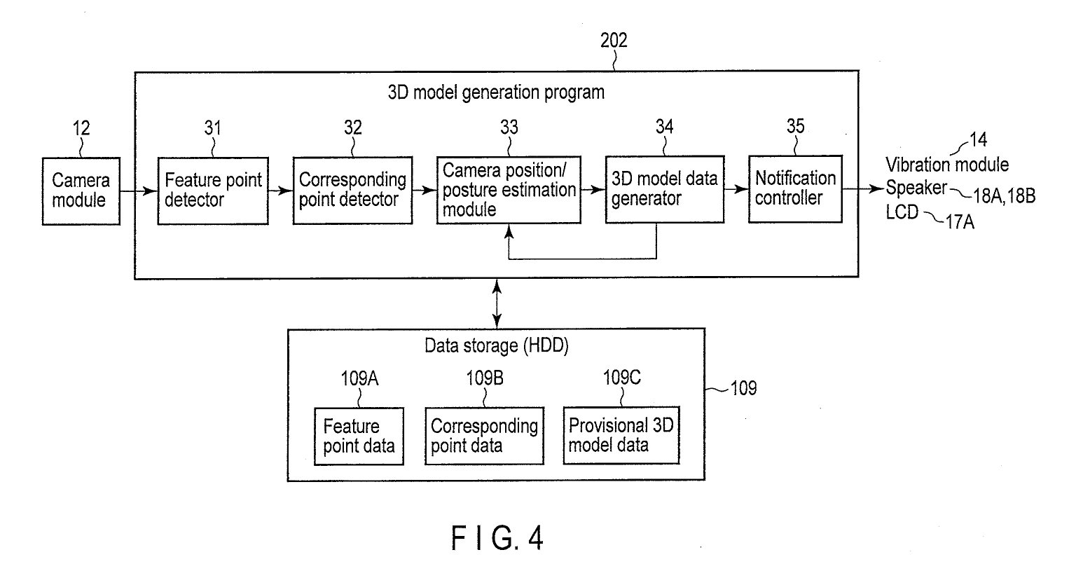

FIG. 4 illustrates an example of the configuration of the 3D model generation program 202 which is executed by the electronic apparatus 10. The 3D model generation program 202 generates 3D model data indicative of a 3D shape of the object 2, by using a plurality of images obtained by capturing the object 2. In addition, the 3D model generation program 202 notifies the user of information relating to the position of the camera 12 which captures images, so that images, which are used for the generation of 3D model data, may efficiently be obtained.

In the description below, for the purpose of simplicity, a process at a time when second and following images have been generated by the camera module 12 is assumed. When a first image has been generated (input), the same process as described below is executed by giving proper initial values. In addition, it is assumed that internal parameters (focal distance, lens distortion, aspect, center of projection, etc.) of the camera 12 are known.

The 3D model generation program 202 includes a feature point detector 31, a corresponding point detector 32, a camera position/posture estimation module 33, a 3D model data generator 34, and a notification controller 35.

The feature point detector 31 analyzes an N-th image which has been generated by the camera module 12, thereby detecting a feature point P_{N} in the N-th image. The feature point P is indicative of a edge, a corner, etc. in an image which has been detected by using a local feature amount by, e.g. scale-invariant feature transform (SIFT) or speeded up robust features (SURF). A plurality of feature points P may be detected from one image. The feature point detector 31 adds information indicative of the detected feature point P_{N} to feature point data 109A which is stored in the data storage (HDD) 109. Accordingly, the feature point data 109A includes information indicative of detected feature points P₁ to P_{N} which have been detected from an N-number of images. The information indicative of each feature point includes, for example, coordinates on an image, a feature amount, etc. of the feature point. The feature point detector 31 notifies the corresponding point detector 32 that the feature point data 109A corresponding to the N-th image (i.e. a newly generated image) has been added.

The corresponding point detector 32 detects, responding to the notification by the feature point detector 31, feature points P₁ to P_{N-1} (hereinafter also referred to as “corresponding points”) in already captured images (i.e. first to (N−1)th images), which correspond to the feature point P_{N} in the N-th image. For example, by template matching, the corresponding point detector 32 detects a feature point (corresponding point) corresponding to the feature point P_{N} in the N-th image, among the feature points P₁ to P_{N-1} detected from the first to (N−1)th images. The corresponding point detector 32 adds information indicative of the detected corresponding point to corresponding point data 109B which is stored in the data storage 109. Accordingly, the corresponding point data 109B is indicative of the relationship in correspondence, between images, of the feature points P₁ to P_{N} detected from the first to N-th images. Thus, the information indicative of each corresponding point includes information indicating, for example, that a feature point X in the first image corresponds to a feature point Y in the second image. The corresponding point detector 32 notifies the camera position/posture estimation module 33 that the corresponding point data 109B corresponding to the N-th image has been added.

The camera position/posture estimation module 33 estimates the position at which the N-th image (i.e. the last captured image) was captured, responding to the notification by the corresponding point detector 32. Specifically, the camera position/posture estimation module 33 estimates the position and posture of the camera 12 (i.e. the external parameters of the camera 12) by using the coordinates of the feature points P_{N} on the image and the three-dimensional (3D) coordinates corresponding to the feature points P_{N}. As the 3D coordinates corresponding to the feature points P_{N}, use are made of 3D coordinates of P₁ to P_{N-1} included in provisional 3D model data 109C. Specifically, the camera position/posture estimation module 33 estimates the position and posture of the camera 12 by using the coordinates on the image of the feature points P_{N}, and the 3D coordinates of the corresponding points corresponding to the feature points P_{N} which have been estimated by using the first to (N−1)th image. The camera position/posture estimation module 33 notifies the 3D model data generator 34 that the position and posture of the camera 12 have been estimated.

In the meantime, the camera position/posture estimation module 33 may estimate the position and posture of the camera 12, by generating silhouette images which are obtained by projecting a provisional 3D model based on the provisional 3D model data 109C in various directions, and collating the generated silhouette images and a silhouette image extracted from the N-th image. Furthermore, the camera position/posture estimation module 33 may estimate the position and posture of the camera 12, by collating the texture of the provisional 3D model and the N-th image.

Responding to the notification by the camera position/posture estimation module 33, the 3D model data generator 34 calculates the 3D coordinates of the feature point P_{N} by using the feature points P_{N} in the N-th image and the corresponding points thereof. Using the calculated 3D coordinates of the feature points P_{N}, the 3D model data generator 34 updates the provisional 3D model data 109C stored in the data storage 109. The 3D model data generator 34 notifies the notification controller 35 that the provisional 3D model data 109C has been updated.

Responding to the notification by the 3D model data generator 34, the notification controller 35 notifies the user of the position at which the object 2 is to be next captured, based on the provisional 3D model data 109C which has been updated by the 3D model data generator 34, and the position of the camera 12 which has been estimated by the camera position/posture estimation module 33. The notification controller 35 notifies the user of the position at which the object 2 is to be next captured, for example, by vibration by the vibrator 14, sound produced by the speaker 18A, 18B, and information displayed on the screen of the LCD 17A.

The notification controller 35 determines the magnitude of vibration, for example, based on the number of newly detected corresponding points. The number of newly detected corresponding points is indicative of, for example, the number of feature points in one image corresponding to feature points in another image, which have first been detected by the N-th image. In other words, the newly detected corresponding point is a feature point, whose corresponding point has not been found in the first to (N−1)th images. The notification controller 35 assumes that as the number of newly detected corresponding points is larger, a greater amount of information for generating 3D model data is obtained at the present position (i.e. the amount of information for 3D model data generation is large), and the notification controller 35 executes such setting that the vibration which is generated by the vibrator 14 becomes larger (stronger). In addition, the notification controller 35 executes such setting that the vibration which is generated by the vibrator 14 becomes smaller (weaker) as the number of newly detected corresponding points is smaller.

The vibrator 14 generates vibration with the magnitude determined by the notification controller 35. By generating strong vibration, the vibrator 14 notifies the user that the capturing is to be continued at the present position. By generating weak vibration (or generating no vibration), the vibrator 14 notifies the user that the capturing at the present position is needless.

The user moves the position of the camera 12 in accordance with the magnitude of vibration. Specifically, when the vibration is strong, the user continues capturing in the vicinity of the present position (e.g. the user performs capturing at the present position by varying the posture of the direction toward the object 2). Thereby, for example, even when occlusion occurs in the present capturing, the object 2 is captured from a posture without occlusion in accordance with the notification by vibration, and the 3D shape of the object 2 can appropriately be reconstructed. On the other hand, when the vibration is weak, the user moves the camera 12 so that the object 2 may be captured from a position different from the present position. Thereby, it is possible to avoid continuous capturing at a position where capturing is needless (i.e. at a position where enough images have been acquired). In the meantime, an image or sound may be output in accordance with the number of newly detected corresponding points. The notification controller 35 displays on the screen of the LCD 17A, for example, information instructing continuous capture at the present position, or information instructing moving the camera 12 to another position of capture. In addition, the notification controller 35 outputs, for example, voice indicative of the above-described information (e.g. “Continue capturing at the present position”) from the speaker 18A, 18B. Furthermore, the notification controller 35 may output from the speaker 18A, 18B, sound effects for notification, with a volume corresponding to the number of newly detected corresponding points.

In addition, the notification controller 35 may notify the position at which the object 2 is to be next captured, in accordance with the degree of missing of the provisional 3D model based on the generated provisional 3D model data 109C.

Specifically, the notification controller 35 detects a missing area of the 3D model by using the generated provisional 3D model data 109C. Then, the notification controller 35 calculates the degree of missing in each detected area (i.e. numerically expresses the magnitude of missing). The degree of missing refers to, for example, the magnitude of a missing area or the number of missing patches.

In addition, the notification controller 35 calculates the degree of missing of the provisional 3D model, which corresponds to the present position of the camera 12. For example, when an L-number of patches of the provisional 3D model are missing within the range of a distance D centering at the present position of the camera 12, the notification controller 35 calculates L/D² as the degree of missing corresponding to the present position. Whether a patch of the provisional 3D model is missing or not is determined, for example, by assuming that the object 2 has a predetermined three-dimensional shape (e.g. sphere) and determining whether there is a hole (a part with no patch) in the provisional 3D model. Besides, the notification controller 35 may calculate D²/M as the degree of missing corresponding to the present position, by using the number M of corresponding points which are present within the range of the distance D centering at the present position of the camera 12.

The notification controller 35 determines the magnitude of vibration, based on the calculated degree of missing corresponding to the present position. The notification controller 35 executes such setting that the vibration which is generated by the vibrator 14 becomes larger (stronger) as the degree of missing corresponding to the present position is greater. In addition, the notification controller 35 executes such setting that the vibration which is generated by the vibrator 14 becomes smaller (weaker) as the degree of missing corresponding to the present position is smaller.

In addition, the notification controller 35 determines the direction (missing-area direction) which is instructed by vibration, based on the present position and the degree of missing of each missing area. The missing-area direction is indicative of, for example, a direction of parallel movement or a direction of rotation at the present position. The notification controller 35 determines a vibration pattern of the vibrator 14, based on the determined direction. Based on the determined direction, for example, the notification controller 35 determines which of a plurality of vibrators 14 provided at plural locations in the electronic apparatus 10 is to be activated.

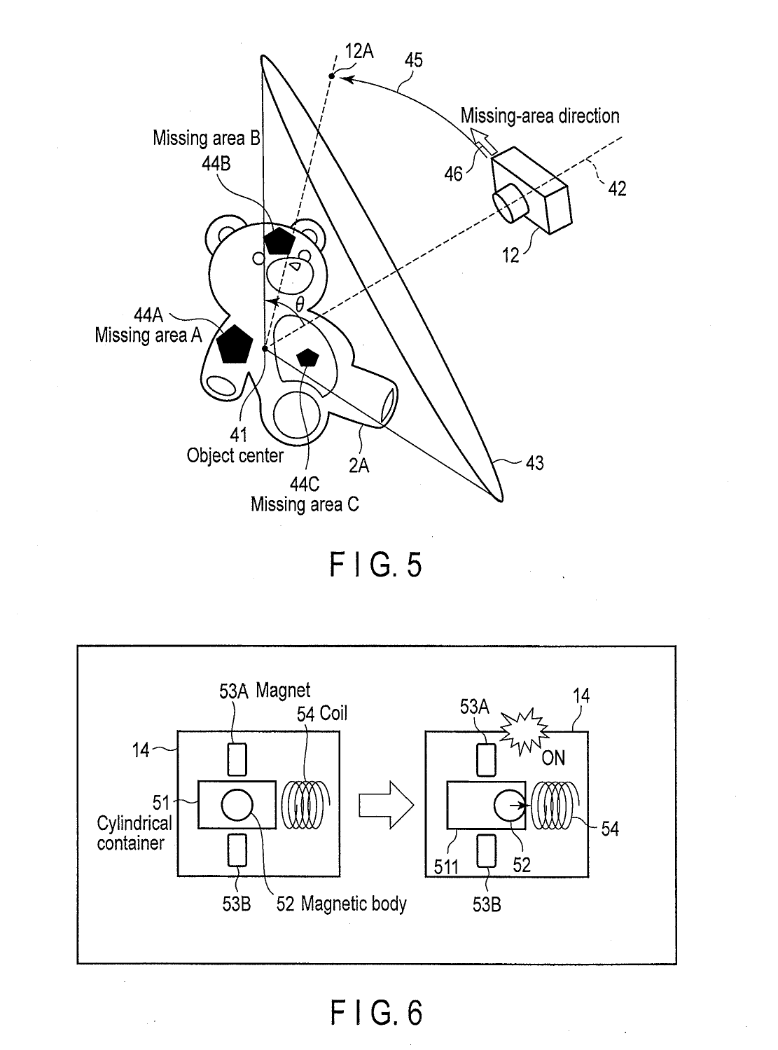

Referring to FIG. 5, the missing-area direction is explained. It is assumed that there are a plurality of missing areas 44A, 44B and 44C on a provisional 3D model 2A, and that the degree of missing of each of the missing areas 44A, 44B and 44C has been calculated.

When there are plural missing areas 44A, 44B and 44C, the camera 12 is guided to one of the missing areas 44A, 44B and 44C. In order to determine this one missing area, a search range 43 for missing areas is set in relation to the provisional 3D model 2A. The search range 43 is represented by, for example, a cone having an apex at an object center (center of gravity) of the provisional 3D model 2A. The size of this cone is determined by, for example, a posture θ to a line segment 42 connecting the object center 41 and the camera 12.

The notification controller 35 selects missing areas 44B and 44C, which are within the search range 43, from among the missing areas 44A, 44B and 44C of the provisional 3D model 2A. If no missing area is found in the search range 43, the search range 43 is broadened (i.e. the posture θ is increased) and missing areas are searched. The notification controller 35 selects the missing area 44B with the greatest degree of missing between the selected missing areas 44B and 44C. Then, the notification controller 35 determines a position 12A at which the selected missing area 44B (i.e. that area of the missing area 44B, which is closer to the present position of the camera 12) can be captured, and determines a direction (missing-area direction) 46 in which the camera 12 is guided along a path 45 connecting the present position of the camera 12 and the position 12A.

The vibrator 14 generates vibration with a magnitude and a vibration pattern (direction) determined by the notification controller 35. The vibrator 14 notifies the user that capturing is to be performed in a direction indicated by the vibration pattern. In addition, the vibrator 14 notifies (“feedback”), by the magnitude of vibration, the user of the breadth of the area that requires capturing (i.e. the breadth of the area which is assumed to be missing from the 3D model). In the meantime, the vibrator 14 may notify the user of a missing-area position (a position for next capturing) by first vibration, and may notify, by second vibration, that the missing area is no longer present.

The user moves the position of the camera 12 in accordance with the direction indicated by the vibration pattern. When the vibration is large, the user captures the object 2 from various positions and postures in the vicinity of the position to which the camera 12 has been moved. Thereby, since the magnitude of the missing area is fed back, the user can intuitively perform capturing. In addition, since the entire surface of the object 2 is not captured at a time but each of missing areas can divisionally (additionally) be captured in accordance with the instruction by the vibrator 14, the capturing by the user becomes easier. Specifically, the capturing may be suspended and, after the position 12A for the next capturing is calculated, the missing area can be captured in accordance with the instruction by the vibrator 14. In this method, since there is no need to execute in real time such processes as generation of the 3D model data 109C and camera position/posture estimation, an increase of the load of computation can be suppressed.

In the meantime, an image or sound may be output in accordance with the degree of missing or the missing-area direction. For example, on the screen of the LCD 17A, the notification controller 35 displays an arrow indicative of the position 12A to which the camera 12 is to be moved, in an overlapping fashion, on the image which is being currently captured. In addition, the notification controller 35 outputs from the speaker 18A, 18B, for example, voice (e.g. “Move camera to right”) indicating the direction toward the position 12A to which the camera 12 is to be moved. Furthermore, the notification controller 35 may output from the speaker 18A, 18B, sound effects for notification, with a volume corresponding to the degree of missing.

FIG. 6 illustrates an example of the structure of the vibrator 14. The vibrator 14 includes a cylindrical (e.g. circular cylindrical) container 51, a magnetic body 52, magnets 53A and 53B, and a coil 54. The magnetic body 52 is, for example, spherical. The magnetic body 52 is contained in the cylindrical container 51, and moves in the right-and-left direction within the cylindrical container 51 in accordance with the variation of a magnetic field. The magnets 53A and 53B are disposed on an upper side portion and a lower side portion of the center of the container 51, for example, such that the container 51 is interposed between the magnets 53A and 53B. In addition, the coil 54 is disposed, for example, on the right side of the container 51.

A magnetic field in the container 51 varies in accordance with a magnetic field by the magnets 53A and 53B and a magnetic field generated by the flow of electric current in the coil 54 (i.e. by power-on of the coil 54). Accordingly, for example, when no current flows in the coil 54 (i.e. when the coil 54 is powered off), the magnetic body 52 in the container 51 is positioned near the center of the container 51 by the magnetic field produced by the magnets 53A and 53B. When current is flowing in the coil 54 (i.e. when the coil 54 is powered on), the magnetic body 52 moves to the right side (to the coil 54 side) in the container 51. The vibrator 14 generates vibration by this movement. Specifically, the vibrator 14 generates vibration with acceleration, thereby to guide the camera 12 in the missing-area direction. In addition, the vibrator 14 controls the magnitude and pattern of vibration by, for example, the magnitude of the magnetic field produced by the coil 54 and the number of times of vibration (the number of times of movement of the magnetic body 52).

FIG. 7 illustrates an example of the arrangement of vibrators 14 which are provided in the computer 10. The notification controller 35 controls the magnitude of vibration of each of two or more vibrators 14 provided in the computer 10, thereby vibrating the computer 10 in a direction (missing-area direction) in which the camera 12 is to be guided. In the example illustrated in FIG. 7, vibrators 14A, 14B, 14C and 14D are disposed on a right side, an upper side, a left side and a lower side within the housing of the computer 10, respectively. The vibrators 14A, 14B, 14C and 14D are vibrated in accordance with a direction in which the camera 12 is to be guided. For example, when the camera 12 is to be guided in a direction indicated by an arrow 56, the notification controller 35 strongly vibrates the vibrator 14A. In the meantime, the vibrator 14 may be provided within the camera module 12.

By the above-described structure, images for 3D model generation can easily be obtained. The 3D model data generator 34 generates 3D model data 109C (reconstructed 3D model) indicative of a 3D shape of the object 2, by using a plurality of images obtained by capturing the object 2. The notification controller 35 notifies the user of the information indicative of the position of the camera 12 where an image is to be next obtained (captured), so that images which are used for the generation of the 3D model data 109C can be efficiently obtained, for example, by using the vibration by the vibrator 14, the sound produced by the speaker 18A, 18B, and the information displayed on the screen of the LCD 17 or the screen of the external display (e.g. TV) connected via the HDMI terminal 1. The notification controller 35 feeds, back to the user, the amount of information of images obtained at the present position (the number of corresponding points obtained by a new image), or the degree of missing corresponding to the present position. Thereby, the user can perform capture in accordance with an intuitive instruction. In the meantime, the notification controller 35 may notify the user of the position 12A to which the camera 12 is to be moved, by taking into account not only the 3D shape of the object 2 but also the texture or reflection characteristic (specular reflection) of the surface of the object.

Next, referring to a flowchart of FIG. 8, a description is given of an example of the procedure of a 3D model generation process which is executed by the 3D model generation program 202. In the description below, for the purpose of simplicity, a process at a time when second and following images have been generated by the camera module 12 is assumed. When a first image has been generated (input), the same process as described below is executed by giving proper initial values.

To start with, the camera module 12 captures a target object 2, thereby generating an N-th image of the object 2 (block B11). Incidentally, N is indicative of the number of captured images. The feature point detector 31 analyzes the generated N-th image, thereby detecting feature points P_{N} in the N-th image (block B12). The feature points P are indicative of edges, corners, etc. in an image which have been detected by using a local feature amount by, e.g. SIFT or SURF.

Subsequently, the corresponding point detector 32 detects feature points P₁ to P_{N-1} (“corresponding points”) in already captured images (i.e. first to (N−1)th images), which correspond to the feature points P_{N} in the newly captured image (i.e. N-th image) (block B13). Specifically, the corresponding point detector 32 detects feature points P₁ to P_{N-1} detected from the first to (N−1)th images, which correspond to the feature point P_{N} in the N-th image.

Then, the camera position/posture estimation module 33 estimates the position and posture of the camera 12 (i.e. the external parameters of the camera 12) by using the coordinates of the feature point P_{N} on the image and the three-dimensional (3D) coordinates corresponding to the feature points P_{N} (block B14). As the 3D coordinates corresponding to the feature points P_{N}, use are made of values which have already been estimated by the 3D model data generator 34 by using the first to (N−1)-th images.

Then, the 3D model data generator 34 calculates 3D coordinates of the feature points P_{N} by using the feature points P_{N} in the N-th image and the corresponding points thereof, thereby generating provisional 3D model data 109 (block B15). Thereby, the 3D coordinates of the feature points, which are used for the estimation of the position and posture of the camera 12 in block B14, are updated. The notification controller 35 then determines whether or not to finish the capturing (block B16). Specifically, the notification controller 35 determines, for example, whether good mapping of texture can be executed for the 3D model based on the provisional 3D model data 109C. In addition, the notification controller 35 determines, for example, whether there is a missing area in the 3D model based on the provisional 3D model data 109C.

When the capturing is finished (YES in block B16), the 3D model generation process is terminated. The notification controller 35 notifies the user of the end of the process, for example, by generating a predetermined vibration pattern indicative of the end by the vibrator 14.

On the other hand, when the capturing is not finished (NO in block B16), the notification controller 35 determines the magnitude of vibration, based on the number of newly detected corresponding points, among the corresponding points detected in block B13 (block B17). The number of newly detected corresponding points is indicative of, for example, the number of feature points in one image corresponding to feature points in another image, which have first been detected by the N-th image. In other words, the newly detected corresponding point is a feature point, whose corresponding point has not been found in the first to (N−1)th images. The notification controller 35 assumes that as the number of newly detected corresponding points is larger, a greater amount of information for generating 3D model data is obtained at the present position (i.e. the amount of information for 3D model data generation is large), and the notification controller 35 executes such setting that the vibration which is generated by the vibrator 14 becomes larger (stronger). In addition, the notification controller 35 executes such setting that the vibration which is generated by the vibrator 14 becomes smaller (weaker) as the number of newly detected corresponding points is smaller. The vibrator 14 generates vibration with the magnitude determined by the notification controller 35 (block B18). By generating strong vibration, the vibrator 14 notifies the user that the capturing is to be continued at the present position. By generating weak vibration (or generating no vibration), the vibrator 14 notifies the user that the capturing at the present position is needless.

The user moves the position of the camera 12 in accordance with the magnitude of vibration. Specifically, when the vibration is strong, the user continues capturing in the vicinity of the present position (e.g. the user performs capturing at the present position by varying the posture of the direction toward the object 2). On the other hand, when the vibration is weak, the user moves the camera 12 and captures the object 2 from a position different from the present position.

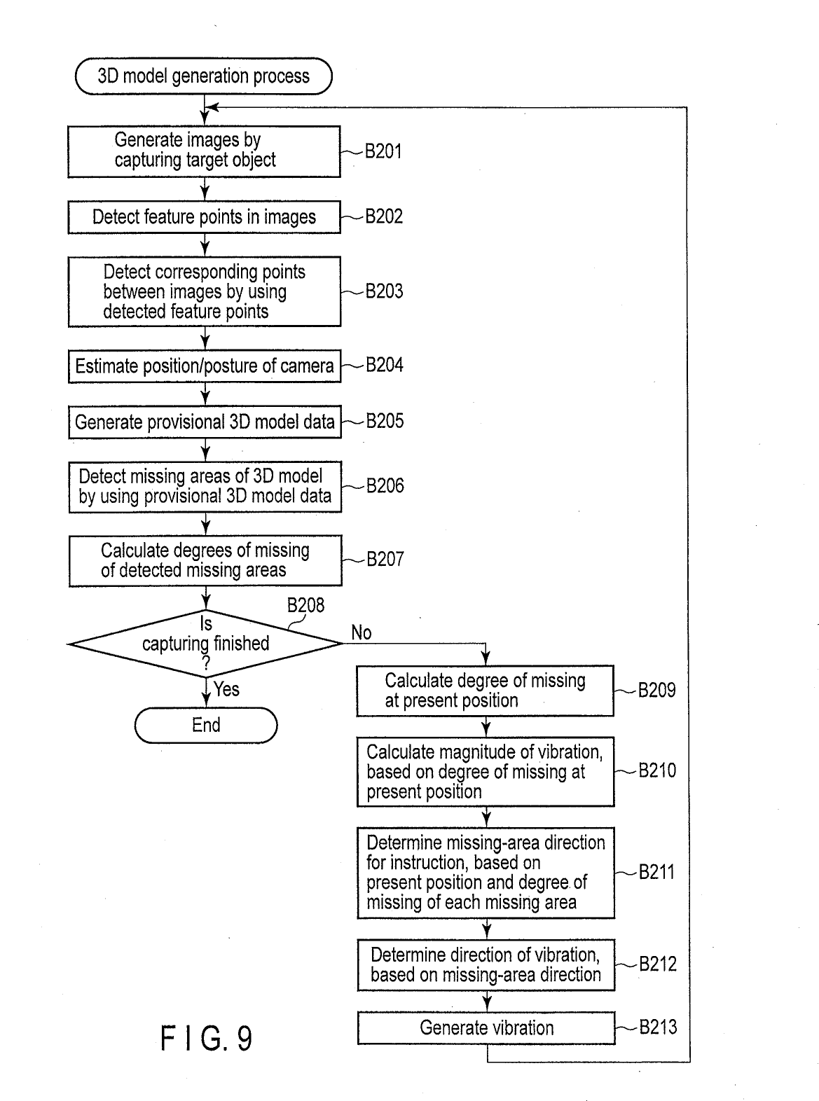

Next, referring to a flowchart of FIG. 9, a description is given of another example of the procedure of the 3D model generation process which is executed by the 3D model generation program 202. In the description below, like the description of FIG. 8, for the purpose of simplicity, a process at a time when second and following images have been generated by the camera module 12 is assumed. When a first image has been generated, the same process as described below is executed by giving proper initial values.

To start with, the camera module 12 captures a target object 2, thereby generating an N-th image of the object 2 (block B201). Incidentally, N is indicative of the number of captured images. The feature point detector 31 analyzes the generated N-th image, thereby detecting feature points P_{N} in the N-th image (block B202). The feature points P are indicative of edges, corners, etc. in an image which has been detected by using a local feature amount by, e.g. SIFT or SURF.

Subsequently, the corresponding point detector 32 detects feature points P₁ to P_{N-1} (“corresponding points”) in already captured images (i.e. first to (N−1)th images), which correspond to the feature points P_{N} in the newly captured image (i.e. N-th image) (block B203). Specifically, the corresponding point detector 32 detects feature points P₁ to P_{N-1} detected from the first to (N−1)th images, which correspond to the feature points P_{N} in the N-th image.

Then, the camera position/posture estimation module 33 estimates the position and posture of the camera 12 (i.e. the external parameters of the camera 12) by using the coordinates of the feature points P_{N} on the image and the three-dimensional (3D) coordinates corresponding to the feature points P_{N} (block B204). As the 3D coordinates corresponding to the feature points P_{N}, use are made of values which have already been estimated by the 3D model data generator 34 by using the first to (N−1)th images.

Then, the 3D model data generator 34 calculates the 3D coordinates of the feature points P_{N} by using the feature points P_{N} in the N-th image and the corresponding points thereof, thereby generating provisional 3D model data 109 (block B205). Thereby, the 3D coordinates of the feature points, which are used for the estimation of the position and posture of the camera 12 in block B204, are updated.

The notification controller 35 detects a missing area of the provisional 3D model 2A by using the generated provisional 3D model data 109C (block B206). The notification controller 35 calculates the degree of missing of each detected area (block B207). Then, the notification controller 35 determines whether or not to finish the capturing, based on the calculated degree of missing (block B208). The notification controller 35 determines that the capturing is to be finished, for example, when no missing area is found or when the maximum value of the degrees of missing in the respective missing areas is less than a threshold value.

If the capturing is finished (YES in block B208), the 3D model generation process is terminated. The notification controller 35 notifies the user of the end of the process, for example, by generating a predetermined vibration pattern indicative of the end by the vibrator 14.

On the other hand, if the capturing is not finished (NO in block B208), the notification controller 35 calculates the degree of missing of the provisional 3D model 2A, which corresponds to the present position of the camera 12 (block B209). The notification controller 35 determines the magnitude of vibration, based on the calculated degree of missing corresponding to the present position (block B210). The notification controller 35 executes such setting that the vibration which is generated by the vibrator 14 becomes larger (stronger) as the degree of missing corresponding to the present position is greater. In addition, the notification controller 35 executes such setting that the vibration which is generated by the vibrator 14 becomes smaller (weaker) as the degree of missing corresponding to the present position is smaller.

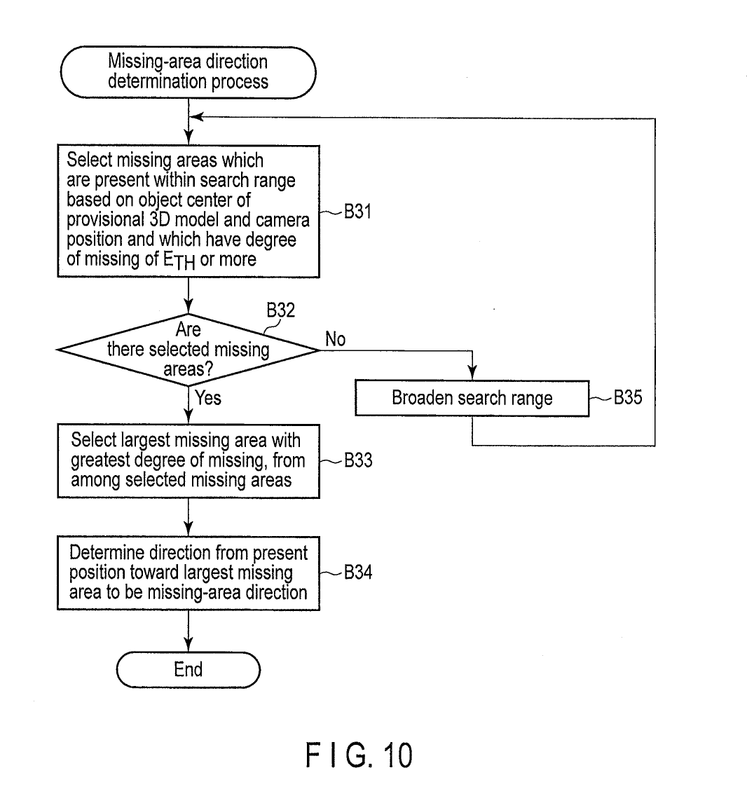

The notification controller 35 determines the direction (missing-area direction) which is instructed by vibration, based on the present position and the degree of missing of each missing area (block B211). The process for determining the missing-area direction will be described later with reference to FIG. 10. The notification controller 35 determines a vibration pattern of the vibrator 14, based on the determined direction (block B212). Based on the determined direction, for example, the notification controller 35 determines which of the vibrators 14A, 14B, 14C and 14D provided at plural locations in the electronic apparatus 10 is to be activated.

The vibrator 14 generates vibration with a magnitude and a vibration pattern determined by the notification controller 35 (block B213). The vibrator 14 notifies the user that capturing is to be performed in a direction indicated by the vibration pattern. In addition, the vibrator 14 notifies, by the magnitude of vibration, the user of the magnitude of the area that requires capture (i.e. the magnitude of the area which is assumed to be missing from the 3D model).

The user moves the position of the camera 12 in accordance with the direction indicated by the vibration pattern. When the vibration is large, the user captures the object 2 from various positions and postures in the vicinity of the position to which the camera 12 has been moved.

A flowchart of FIG. 10 illustrates an example of the procedure of a missing-area direction determination process.

The notification controller 35 selects missing areas 44B and 44C from among the missing areas 44A, 44B and 44C of the provisional 3D model 2A based on the provisional 3D model data 109C, the missing areas 44B and 44C being within the search range 43 based on the object center 41 of the provisional 3D model 2A and the present position of the camera 12 and having degrees of missing which are a threshold value E_{TH} or more (block B31). The search range 43 is an area represented by, for example, a cone having an apex at the object center 41. Then, the notification controller 35 determines whether there is a selected missing area or not (block B32).

If there is no missing area which is selected (NO in block B32), the search range 43 for missing areas is broadened (block B35). Then, the process returns to block B31, and a missing area, which is present within the broadened search range 43 and has a degree of missing which is the threshold value E_{TH} or more, is selected.

If there are missing areas which are selected (YES in block B32), the notification controller 35 selects the missing area 44B with the greatest degree of missing between the selected missing areas 44B and 44C (block B33). Then, the notification controller 35 determines the direction 46 in which the camera 12 is to be guided along the path 45 connecting the present position of the camera 12 and the position 12A at which the greatest missing area 44B can be captured (block B34).

As has been described above, according to the present embodiment, images for 3D model generation can easily be obtained. The 3D model data generator 34 generates the 3D model data 109C (reconstructed 3D model) indicative of the 3D shape of the object 2, by using a plurality of images obtained by capturing the object 2. The notification controller 35 notifies the user of the information indicative of the position 12A of the camera where an image is to be next obtained (captured), so that images which are used for the generation of the 3D model data 109C can be efficiently obtained, for example, by using the vibration by the vibrator 14, the sound played by the speaker 18A, 18B, and the information displayed on the screen of the LCD 17 or the screen of the external display (e.g. TV) connected via the HDMI terminal 1. In accordance with this notification, the user varies the position or posture of the camera 12, thus being able to efficiently obtain images for generating the 3D model data indicative of the 3D shape of the object 2. Incidentally, the notification controller 35 may notify the user of the timing for pressing the shutter button of the camera 12, based on the present position of the camera 12 and the position 12A of the camera where an image is to be next captured.

All the procedures of the 3D model generation process according to this embodiment can be executed by software. Thus, the same advantageous effects as with the present embodiment can easily be obtained simply by installing a computer program, which executes the procedures of the 3D model generation process, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a three-dimensional model generator configured to generate three-dimensional model data by using a plurality of images in which a target object of a three-dimensional model is captured;
a target-object position-estimation module configured to estimate a position of the target object in a last captured image of the plurality of images; and
a notification controller configured to notify a user of a position at which the target object is to be next captured based on the generated three-dimensional model data and the estimated target-object position,
wherein the three-dimensional model generator is configured to update the three-dimensional model data by using a newly captured image of the target object.

2. The electronic apparatus of claim 1, wherein the notification controller is configured to notify the user of the position at which the target object is to be next captured by vibrating the electronic apparatus.

3. The electronic apparatus of claim 2, further comprising:
a feature point detector configured to detect a plurality of feature points from the plurality of images; and
a corresponding point detector configured to detect corresponding points between the plurality of images by using the plurality of feature points,
wherein the notification controller is configured to determine a magnitude of vibration with which to vibrate the electronic apparatus based on a number of first corresponding points among the detected corresponding points, wherein the first corresponding points have been newly detected in the last captured image.

4. The electronic apparatus of claim 2, wherein the notification controller is configured to detect a missing area of the three-dimensional model based on the three-dimensional model data, and wherein the notification controller is further configured to determine a magnitude of vibration with which to vibrate the electronic apparatus based on a magnitude of the missing area.

5. The electronic apparatus of claim 2, wherein the notification controller is configured to detect a missing area of the three-dimensional model based on the three-dimensional model data, and wherein the notification controller is further configured to determine a direction of vibration with which to vibrate the electronic apparatus based on a direction from the target-object position toward the missing area.

6. The electronic apparatus of claim 5, wherein the notification controller is configured to vibrate the electronic apparatus in the determined direction of vibration by controlling a magnitude of vibration of each of two or more vibrators in the electronic apparatus.

7. The electronic apparatus of claim 1, wherein the notification controller is configured to display information on a screen, wherein the displayed information is indicative of the position at which the target object is to be next captured.

8. The electronic apparatus of claim 1, wherein the notification controller is configured to output sound indicative of the position at which the target object is to be next captured.

9. A three-dimensional model generation support method comprising:
generating three-dimensional model data by using a plurality of images in which a target object of a three-dimensional model is captured;
estimating a position of the target object in a last captured image of the plurality of images; and
notifying a user of a position at which the target object is to be next captured based on the generated three-dimensional model data and the estimated target-object position,
wherein generating the three-dimensional model data comprises updating the three-dimensional model data by using a newly captured image of the target object.

10. A computer-readable, non-transitory storage medium having stored thereon a program which is executable by a computer, the program controlling the computer to execute functions of:
generating three-dimensional model data by using a plurality of images in which a target object of a three-dimensional model is captured;
estimating a position of the target object in a last captured image of the plurality of images; and
notifying a user of a position at which the object is to be next captured based on the generated three-dimensional model data and the estimated target-object position,
wherein generating the three-dimensional model data comprises updating the three-dimensional model data by using a newly captured image of the target object.
